(19) United States
(12) Patent Application Publication
(10) Pub. No.: US 2011/0110779 A1
(43) Pub. Date: May 12, 2011

(54) FLUID TURBINE FEATURING ARTICULATED BLADES AND PHASE-ADJUSTED CAM

(76) Inventors: Thomas Glenn Stephens, Grand Prairie, TX (US); Peter Chris Skarzenski, Dallas, TX (US); Adam J. Tibbitts, Victoria, TX (US); Brandon D. Brantley, JR., Fort Worth, TX (US); Bruce Eugene Swanson, Irving, TX (US)

(21) Appl. No.: 12/637,498

(22) Filed: Dec. 14, 2009

Related U.S. Application Data
(63) Continuation-in-part of application No. 12/614,232, filed on Nov. 6, 2009.

(51) Int. Cl. B64C 11/00

(52) U.S. Cl. 416/153

(57) ABSTRACT

A fluid turbine comprising a rotor, having an axis of rotation, comprising at least two rotor blades disposed at a radius from the axis of rotation, each rotor blade having a pitch axis and a variable pitch angle. The fluid turbine comprises a mechanism operable to control the pitch angle of at least one rotor blade about its pitch axis and to vary the pitch angle of the rotor blade between various pitch angles as the blade moves radially about the axis of rotation of the rotor.

### SUMMARY OF THE INVENTION

According to a first aspect, the present disclosure relates to a fluid turbine comprising a rotor and a phase-adjustable mechanism. The rotor has an axis of rotation, and comprises at least two rotor blades disposed at a radius from the axis of rotation, each rotor blade having a pitch axis and a variable pitch angle. The phase-adjustable mechanism is operable to control the pitch angle of at least one rotor blade about its pitch axis and to vary the pitch angle of the rotor blade from a first pitch angle at a first radial location about the axis of rotation to a second pitch angle at a second radial location about the axis of rotation.

According to a second aspect, the present disclosure relates to a fluid turbine comprising a rotor and a pitch angle control mechanism. The rotor has an axis of rotation, and comprises at least two rotor blades disposed at a radius from the axis of rotation, each rotor blade having a first end, a second end, a first mounting point, a second mounting point, a pitch axis and a variable pitch angle, each of the first and second mounting points being disposed inboard of the first and second ends. The pitch angle control mechanism is operable to control the pitch angle of at least one rotor blade about its pitch axis and to vary the pitch angle of the rotor blade from a first pitch angle at a first radial location about the axis of rotation to a second pitch angle at a second radial location about the axis of rotation.

According to a third aspect, the present disclosure relates to a fluid turbine comprising a rotor and a pitch angle control mechanism. The rotor has an axis of rotation and comprises a first hub, a second hub, an array of at least two struts, having strut covers disposed thereabout, extending from each of the first and second hubs, and at least two rotor blades, each secured to the distal end of a strut and having a pitch axis and a variable pitch angle. The mechanism is operable to control the pitch angle of at least one rotor blade about its pitch axis and to vary the pitch angle of the rotor blade from a first pitch angle at a first radial location about the axis of rotation to a second pitch angle at a second radial location about the axis of rotation.

### BRIEF DESCRIPTION OF THE DRAWINGS

FIG. 1 is an isometric view of a fluid turbine according to certain embodiments of the present disclosure;

FIG. 2 is a side view of the fluid turbine according to certain embodiments of the present disclosure;

FIG. 3 is a first end view of the fluid turbine according to certain embodiments of the present disclosure;

FIG. 4 is a second end view of the fluid turbine according to certain embodiments of the present disclosure;

FIG. 5 is an end view of a second embodiment of a fluid turbine;

FIG. 6 is a first isomeric detail view of the hub at the first end of the fluid turbine according to certain embodiments of the present disclosure;

FIG. 7 is a second isomeric detail view of the hub of FIG. 5 with one of the cam covers removed;

FIG. 8 is an end view of the cam clocking mechanism disposed in the hub at the first end of the fluid turbine;

FIG. 9 is a view of the underside of a rotor blade;

FIG. 10 is a cutaway view of the rotor blade showing the blade attachment mechanism and pitch control linkage;

FIG. 11 is an isometric view of a turbine blade strut cover; and

FIG. 12 is a section view of a turbine blade strut cover.

### DETAILED DESCRIPTION OF THE DRAWINGS

A system and method of the present patent application will now be described with reference to various examples of how the embodiments can best be made and used. Like reference numerals are used throughout the description and several views of the drawings to indicate like or corresponding parts, wherein the various elements are not necessarily drawn to scale.

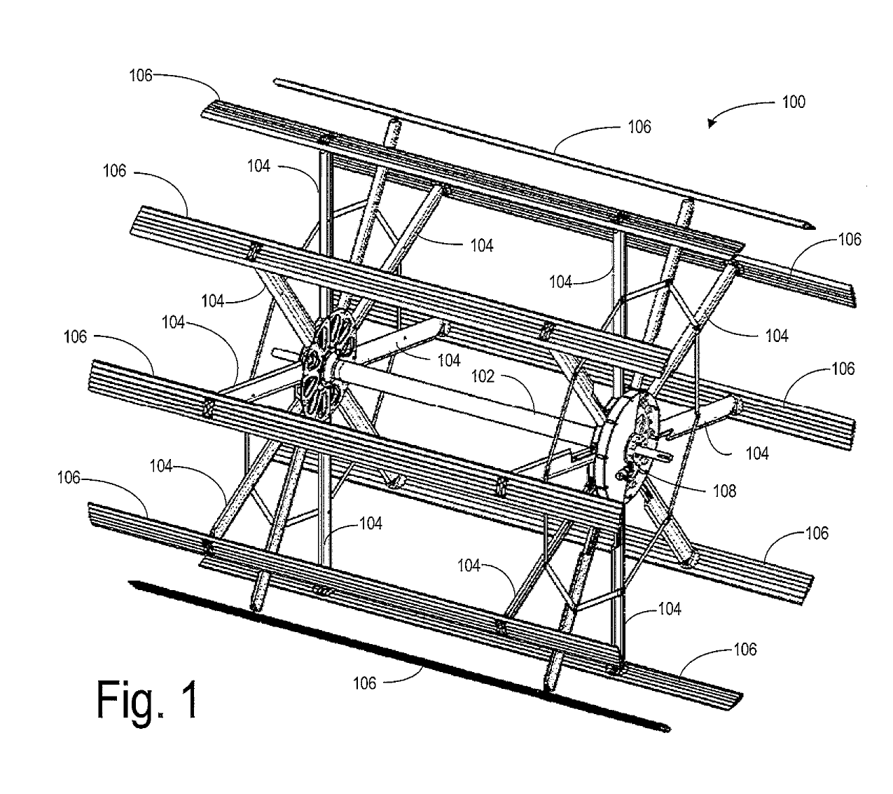

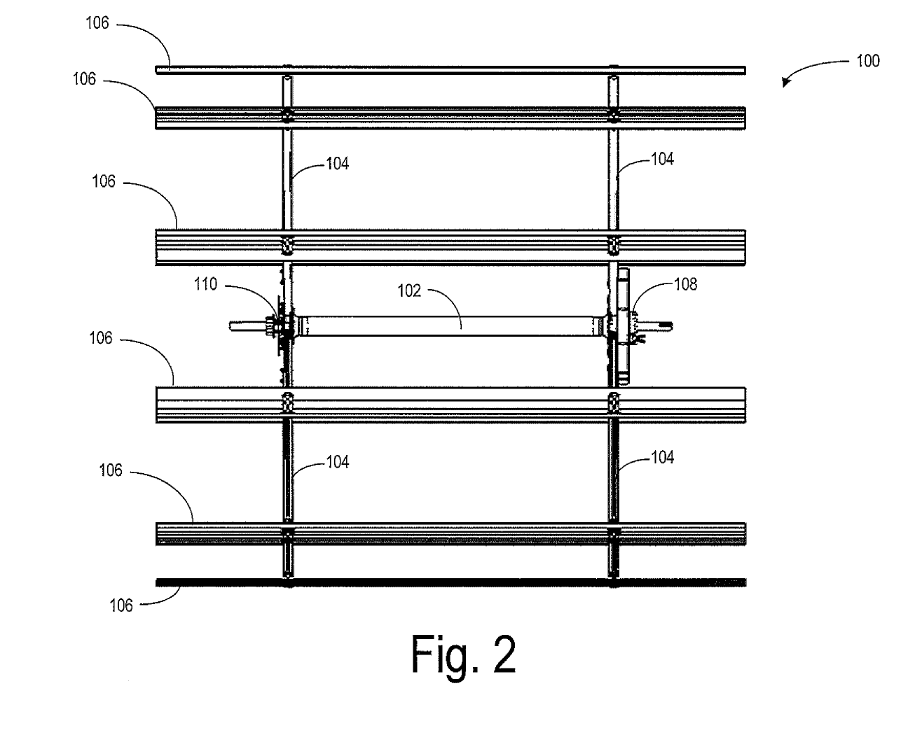

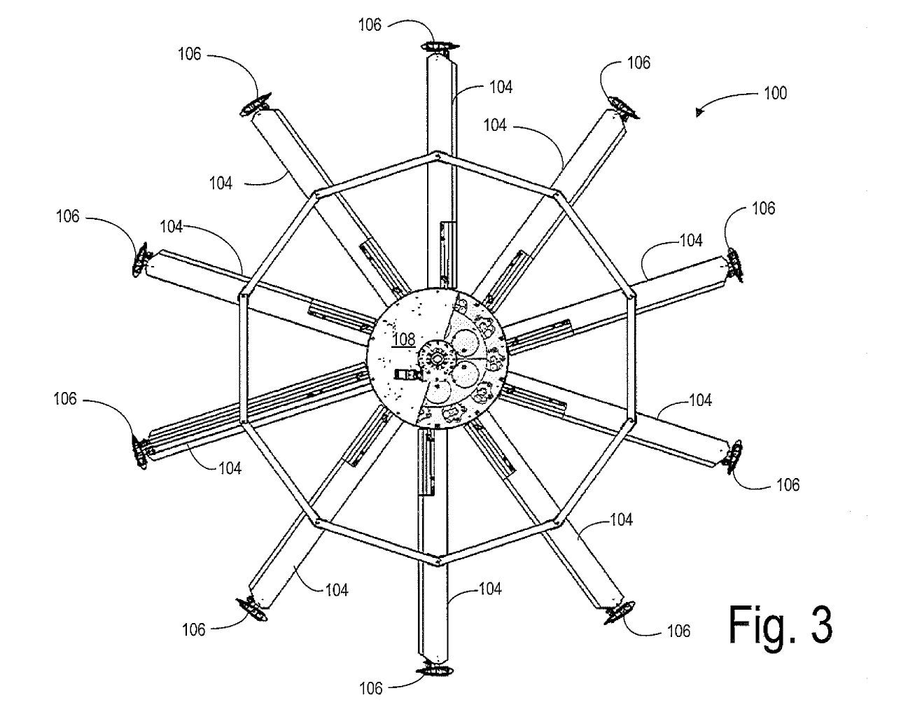

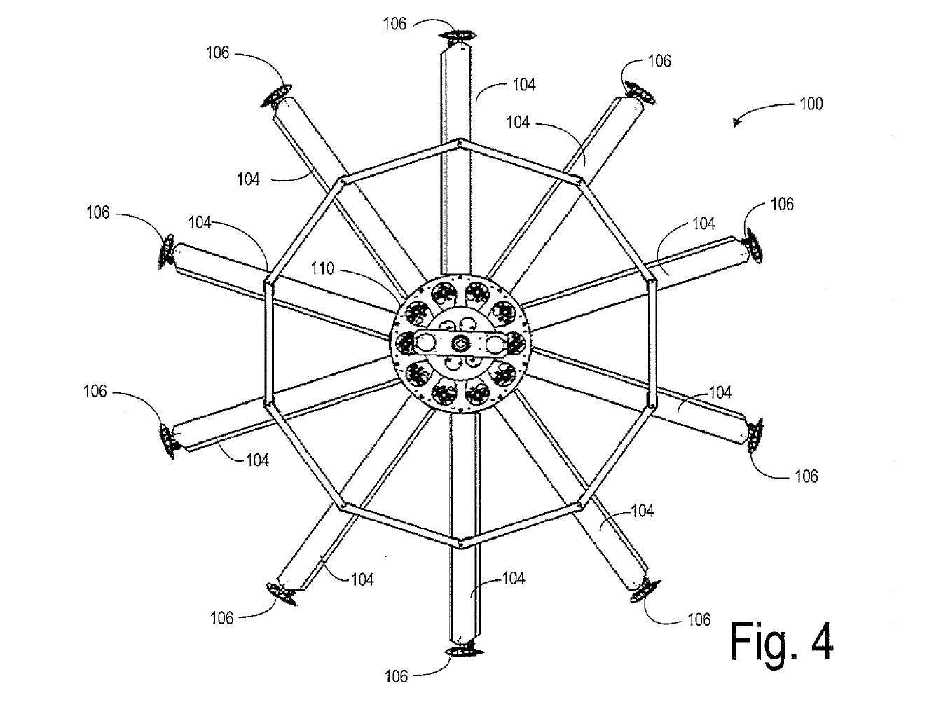

FIG. 1 is an isometric view of a fluid turbine 100 according to certain embodiments of the present disclosure. FIG. 2 is a side view of the fluid turbine according to certain embodiments of the present disclosure. FIG. 3 is a first end view of the fluid turbine according to certain embodiments of the present disclosure. FIG. 4 is a second end view of the fluid turbine according to certain embodiments of the present disclosure.

Structurally, turbine 100 consists of a rotor assembly comprising a torque tube 102. Torque tube 102 is designed to prevent rotor hubs 108, 110 from rotating independently of one another. Torque tube 102 is oriented along a central axis which is intended to be disposed generally perpendicular to the direction of fluid flow. The turbine 100 comprises arrays of radially-disposed struts 104, each mounted to one of rotor hubs 108, 110 at its proximal end and a rotor blade 106 at its distal end. The rotor blades 106 shown in FIG. 1 are tapered airfoils/hydrofoils having a clearly defined leading and trailing edge. Turbine 100 shown in FIG. 1 comprises 10 blades, but alternate embodiments may have more or fewer blades, depending on the application. The rotor blades 106 are attached to the struts 104 in such a manner as to allow the rotor blades 106 to be individually pivoted with respect to the axis of rotation of turbine 100, thus altering the pitch angle of each rotor blade 106 with respect to the direction of fluid flow through turbine 100. The angle of the rotor blades may be controlled via mechanical linkages, hydraulics, pneumatics, linear or rotary electromechanical actuators, or any combination thereof. In certain embodiments, the rotor pitch angle profile may be controlled by a cam-and-follower mechanism operating in concert with one or more of the above systems of actuation, as set forth in further detail below.

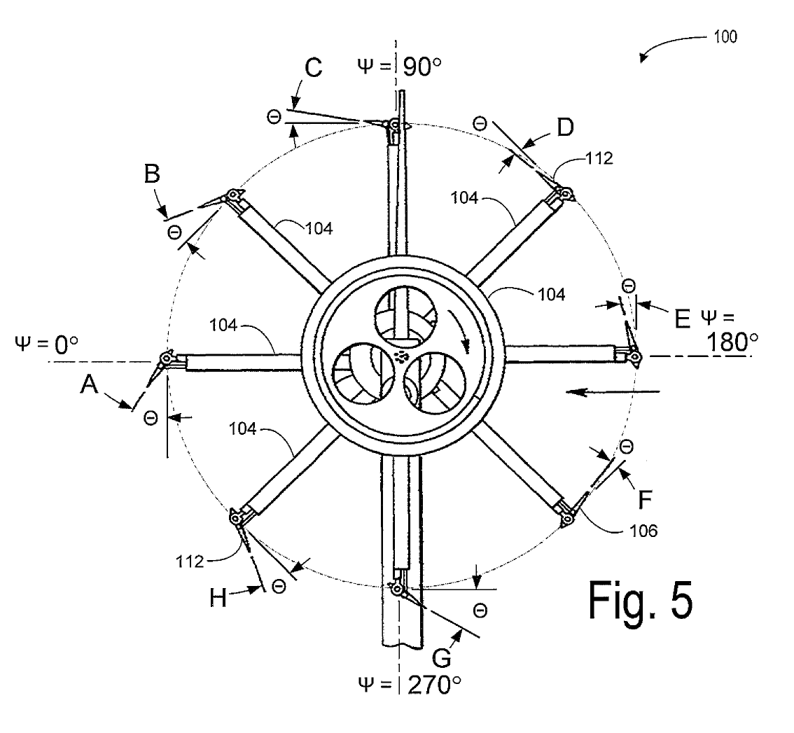

FIG. 5 is an end view of a fluid turbine 100 according to certain embodiments of the present disclosure. The fluid turbine 100 shown in FIG. 5 incorporates eight rotor blades 106. The pitch angle of the eight rotor blades 106 are designated angles A-H with the blade pitch angle of the rotor blade at angular position 0 being designated angle “A.” The blade pitch angles of the other rotor blades 106 are designated angles “B” through “H,” at multiples of 45 degrees from angle “A,” clockwise. Thus, angle “B” is the pitch angle of a rotor blade 106 disposed at an angular position 45 degrees clockwise from 0, angle “C” is the pitch angle of a rotor blade 106 disposed at an angular position 90 degrees from 0, and so forth. As each rotor blade 106 moves radially about torque tube 102, the pitch of the rotor blade 106 is varied with respect to the strut 104 to which it is attached. Thus, a rotor blade 106 may be disposed at a different pitch at position ‘A’ than it will at position ‘B,’ and the pitch at position ‘B’ will be different than the pitch at position ‘C.’ The blade pitch is articulated according to a predetermined profile or pattern. Control of the blade pitch movement pattern may be effectuated by any of the types of mechanisms described above.

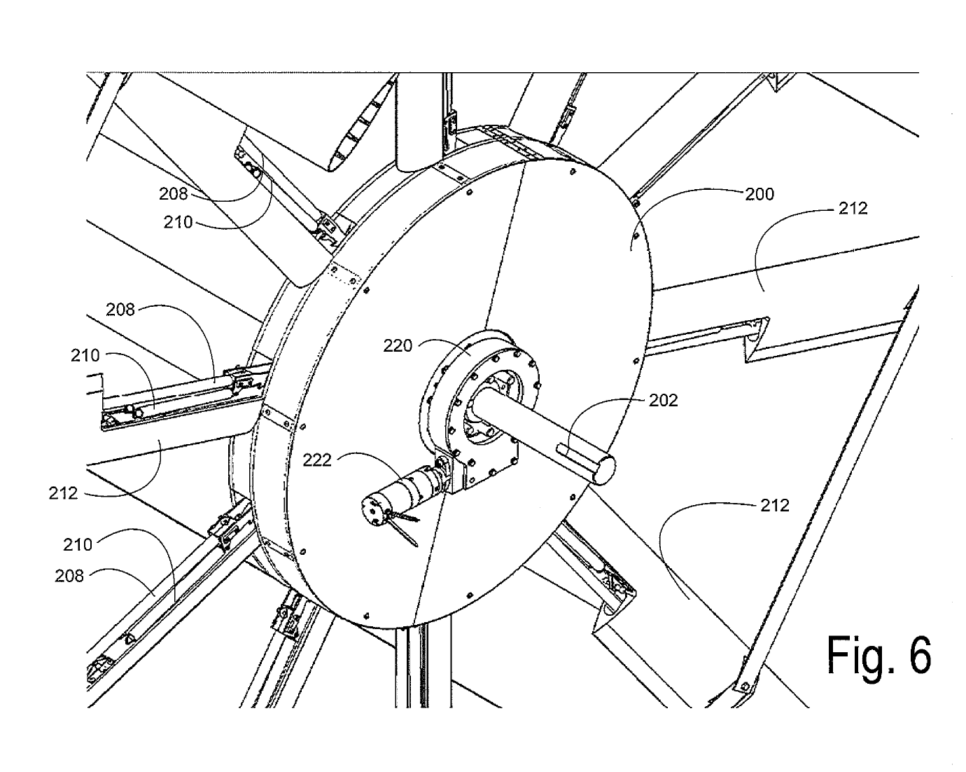

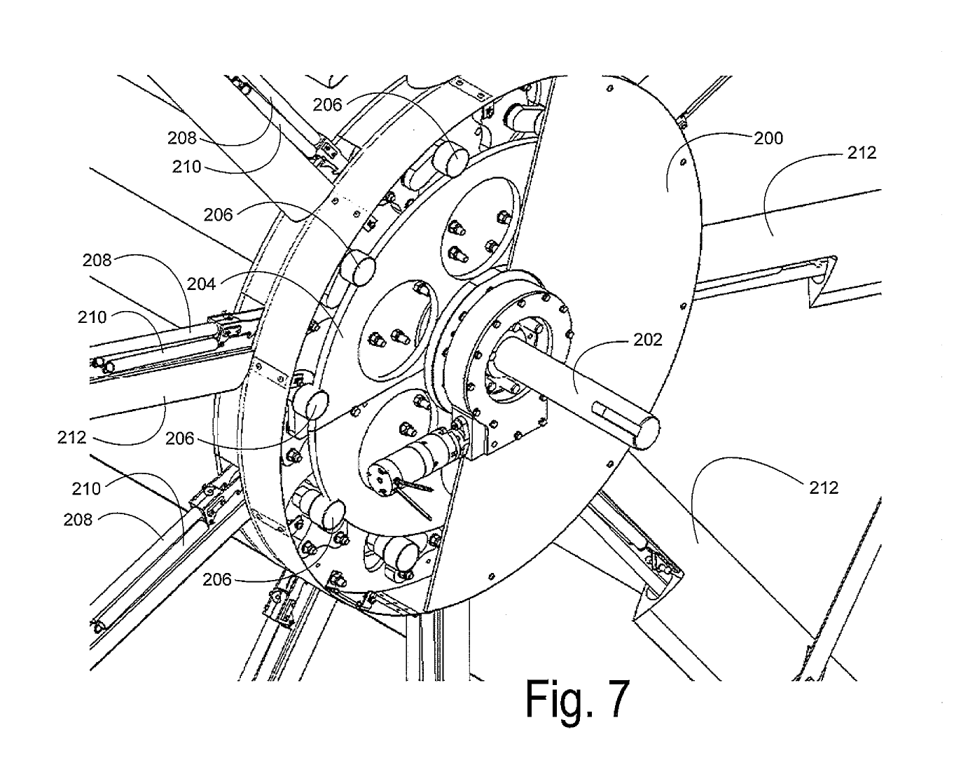

FIG. 6 is an isometric view of a rotor hub 108 according to one embodiment of the present invention. FIG. 7 is an isometric view of the rotor hub 108 with a portion of the cover 200 removed to reveal a cam mechanism disposed therein. Hub 108 revolves about stub axle 202 as the rotor revolves about its axis of rotation. Cam 204 remains mostly stationary inside hub 108 as the rotor revolves around it. A set of rocker assemblies 206, pivotally secured to hub 108, ride on the outer surface of cam 204 as the hub 108 revolves. Each rocker assembly 206 is connected to an actuation rod 208 and at least one spring 210 secured to a strut 104 at one end and the actuation rod 208 at the other. The springs 210 hold the cam followers securely against the outer surface of the cam 204. Each actuation rod 208 runs parallel to the strut 104 for a rotor blade 106, within a lengthwise aperture in the strut cover 212.

Each actuation rod 208 is secured to a rocker assembly 206 at its proximal end and to a rotor blade at its distal end. Each actuation rod 208 controls the pitch of a particular rotor blade according to the position of a particular rocker assembly 206, which is, in turn, controlled by the profile of the outer surface of the cam 204 at the point of contact between the cam 204 and the cam follower of the rocker assembly 206. Thus, a rotor blade at a given radial location will be articulated to a given blade pitch. As a rotor blade moves about the axis of rotation of the rotor, it will be articulated according to the pattern of the cam.

A clocking motor 222 actuates a clocking mechanism 220 secured to the cam 204. The clocking mechanism is operable to vary the phase relationship between the cam 204 and the rotor blades 106 by advancing or retarding the angular position of the cam 204 with respect to the angular position of the rotor blades 106. The structure of the clocking mechanism is set forth in further detail below.

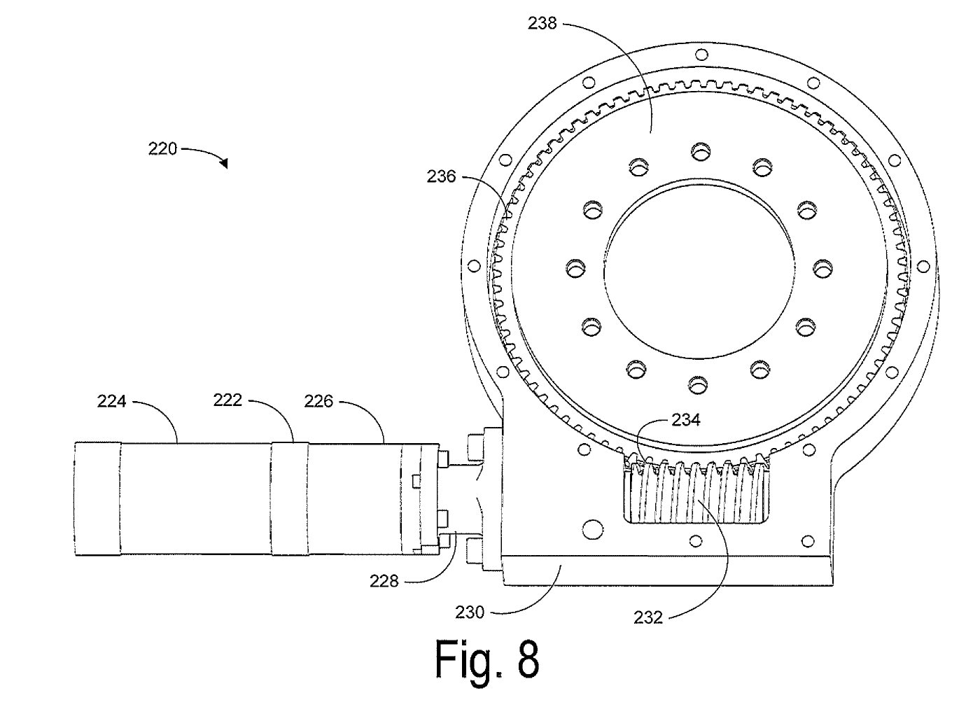

FIG. 8 is an end detail view of clocking mechanism 220. As seen in FIG. 8, clocking mechanism 220 comprises a clocking motor 222 secured to a worm gear mechanism 230. Clocking motor 224 comprises a rotor-stator assembly 224 and a gearhead 226, though in different embodiments, the gearhead 226 may or may not be included. Clocking motor 222 is secured to worm gear assembly 230 by motor mount 228.

Within worm gear assembly 230, the helical worm teeth 234 of worm gear 232 mesh with the helical gear teeth 235 of gear 236. As the worm gear 232 rotates, the helical worm teeth 234 exert pressure on the helical gear teeth 234, thus imparting a torque on gear 236, which is secured to cam 204. Through the use of clocking mechanism 220, the clocking motor 222 is able to vary the angle of cam 204, and thereby vary the phase of the cam profile with respect to the rotor blades in order to optimize the blade pitch profile to match the prevailing conditions, which may include fluid velocity, fluid flow direction, fluid turbulence and fluid density, as examples.

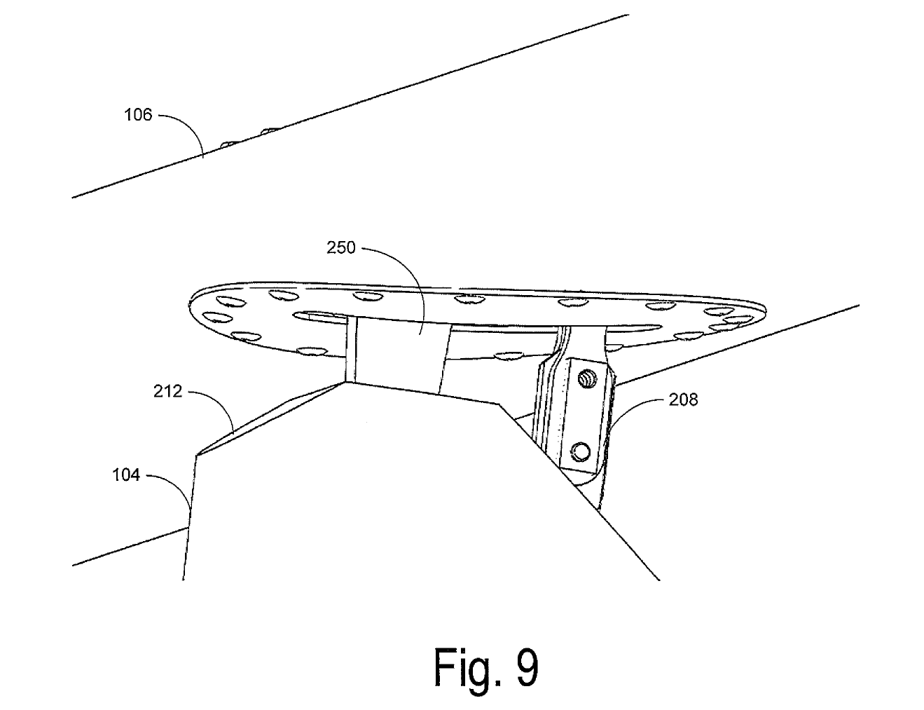

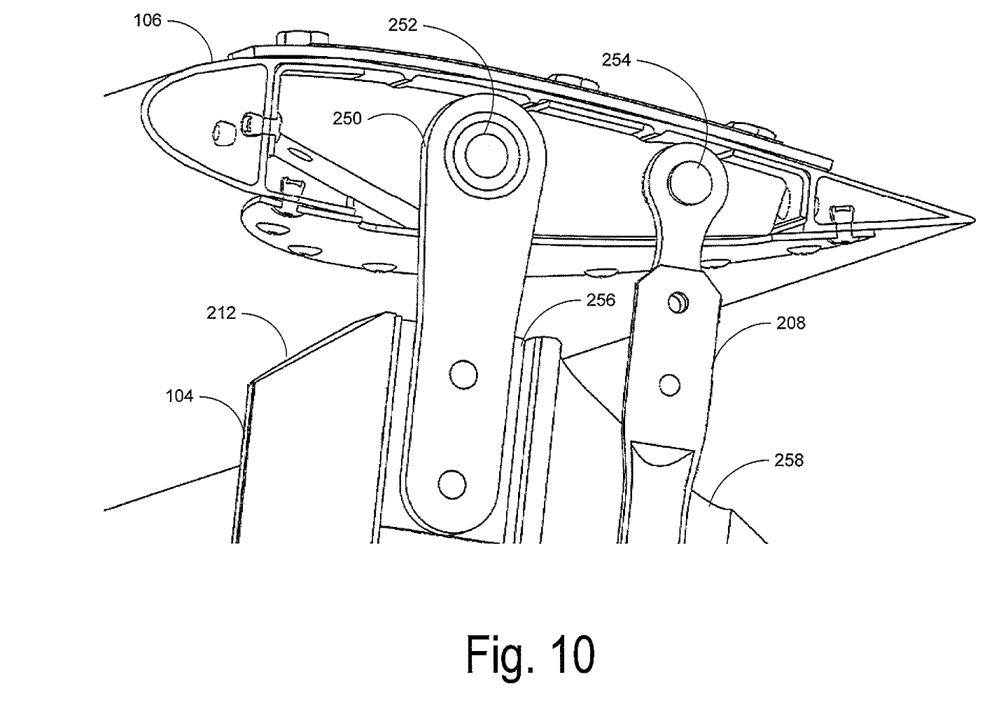

FIG. 9 is an oblique detail view of the underside of a rotor blade. FIG. 10 is an oblique cutaway view of the rotor blade showing the blade attachment mechanism and pitch control linkage. As seen in FIGS. 9 and 10, each rotor blade 106 is secured to a strut 104 by means of a pivot joint 252 allowing the rotor blade 106 freedom of movement to be moved to different pitch angles. As described above, the pitch angle of each rotor blade is controlled by an actuation rod 208 secured to the rotor blade at rod end 254.

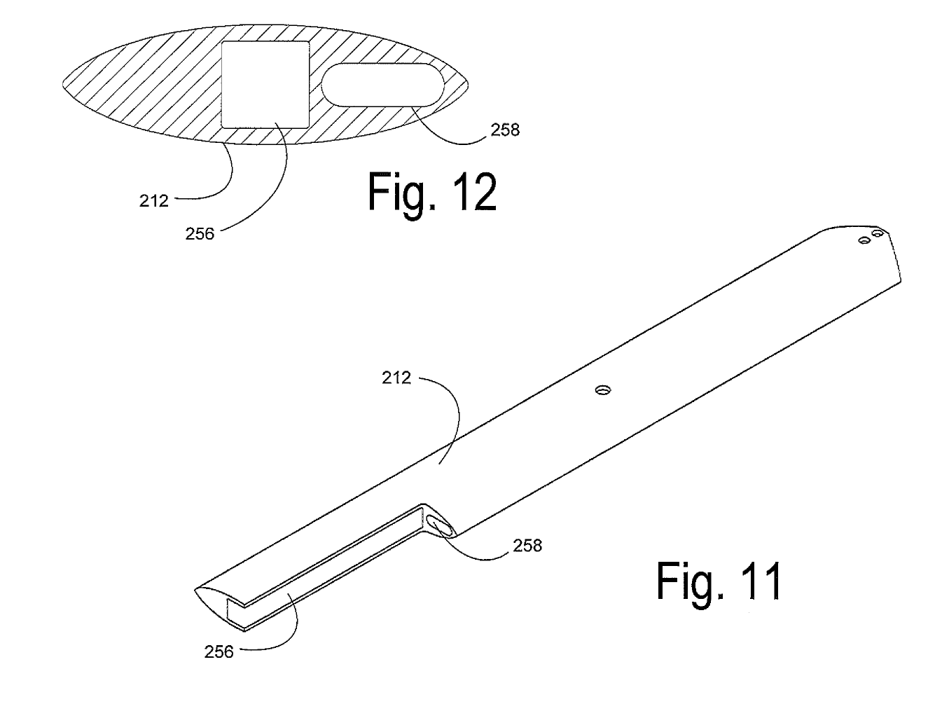

In order to improve aerodynamic efficiency and protect the structural integrity of the mechanism, each strut 104 and actuation rod 208 are disposed within a strut cover 212. Each strut 104 is disposed within a centrally-located and axially-aligned strut aperture 256, and each actuation rod 208 is disposed within a parallel actuation rod aperture 258. The structure of a strut cover is shown in FIGS. 11 and 12.

It is believed that the operation and construction of the embodiments of the present patent application will be apparent from the detailed description set forth above. While the exemplary embodiments shown and described may have been characterized as preferred, it should be readily understood that various changes and modifications could be made therein without departing from the scope of the present invention as set forth herein.

What is claimed is:

1. A fluid turbine comprising:
a rotor, having an axis of rotation, comprising at least two rotor blades disposed at a radius from the axis of rotation, each rotor blade having a pitch axis and a variable pitch angle; and
a phase-adjustable mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation.

2. The fluid turbine of claim 1, wherein the phase-adjustable mechanism comprises a cam having a pitch profile.

3. The fluid turbine of claim 1, wherein the phase of the phase-adjustable mechanism is varied by means of a worm gear.

4. The fluid turbine of claim 1, wherein the phase-adjustable mechanism comprises a cam secured to a worm gear mechanism.

5. The fluid turbine of claim 4, wherein the phase-adjustable mechanism further comprises a set of cam followers, each operably connected to a proximal end of an actuating rod having its distal end operably connected to a pitch control linkage point on a rotor blade.

6. The fluid turbine of claim 4, wherein the phase-adjustable mechanism further comprises a motor operably connected to the worm gear of the worm gear mechanism.

7. The fluid turbine of claim 1, wherein the phase-adjustable mechanism is operable to adjust the phase of the blade pitch profile according to prevailing conditions, which may include conditions of the fluid and rotational velocity of the turbine.

8. A fluid turbine comprising:
a rotor, having an axis of rotation, comprising at least two rotor blades disposed at a radius from the axis of rotation, each rotor blade having a first end, a second end, a first mounting point, a second mounting point, a pitch axis and a variable pitch angle, each of the first and second mounting points being disposed inboard of the first and second ends; and
a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation.

9. The fluid turbine of claim 8, wherein the mechanism comprises an array of actuating rods.

10. The fluid turbine of claim 8, wherein each rotor blade is connected to at least two struts.

11. The fluid turbine of claim 8, wherein the pitch of each rotor blade is controlled by an actuating rod extending from a rotor hub to a rod end secured to the rotor blade.

12. The fluid turbine of claim 11, wherein each actuating rod is disposed adjacent to a strut.

13. The fluid turbine of claim 8, wherein each rotor blade is secured to struts at pivot points.

14. The fluid turbine of claim 8, wherein mechanism operable to control the pitch angle of at least one rotor blade comprises a cam-and-follower mechanism.

15. A fluid turbine comprising:
a rotor, having an axis of rotation, comprising a first hub, a second hub, an array of at least two struts, having strut covers disposed thereabout, extending from each of the first and second hubs, and at least two rotor blades, each secured to the distal end of a strut and having a pitch axis and a variable pitch angle; and
a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation.

16. The fluid turbine of claim 15, wherein at least one strut cover has an aerodynamic shape.

17. The fluid turbine of claim 15, wherein at least one strut cover comprises a centrally-located and axially-aligned aperture.

18. The fluid turbine of claim 17, wherein at least one strut is disposed within at least one centrally-located and axially-aligned aperture within at least one strut cover.

19. The fluid turbine of claim 15, wherein the rotor further comprises an actuating rod disposed adjacent to at least one strut.

20. The fluid turbine of claim 19, wherein the actuating rod is disposed within an aperture in the strut cover.
